(19) United States
(12) Patent Application Publication
(10) Pub. No.: US 2020/0086534 A1
(43) Pub. Date: Mar. 19, 2020

(54) IMPRINT METHOD, IMPRINT APPARATUS, METHOD OF MANUFACTURING ARTICLE

(71) Applicant: CANON KABUSHIKI KAISHA, Tokyo (JP)

(72) Inventors: Tetsuji Okada, Saitama-shi (JP); Tosiya Asano, Utsunomiya-shi (JP); Yosuke Murakami, Utsunomiya-shi (JP)

(21) Appl. No.: 16/569,765

(22) Filed: Sep. 13, 2019

(30) Foreign Application Priority Data
Sep. 18, 2018 (JP) 2018-174189

(51) Int. Cl. B29C 43/58; B29C 43/02

(52) U.S. Cl. CPC B29C 43/58; B82Y 40/00; B29C 43/021

(57) ABSTRACT

The present invention provides an imprint method of forming a pattern of an imprint material on a substrate by using a mold, the method including obtaining, before bringing the mold and the imprint material into contact with each other, a correction parameter for correcting deformation of a pattern of the mold caused by bringing the mold and the imprint material on the substrate into contact with each other, and reducing the deformation of the pattern of the mold by moving at least one of the mold and the substrate by a moving unit configured to relatively move the mold and the substrate in a direction parallel to a surface of the substrate in accordance with the correction parameter in a state in which the mold and the imprint material on the substrate are in contact with each other.

### BACKGROUND OF THE INVENTION

### Field of the Invention

The present invention relates to an imprint method, an imprint apparatus, and a method of manufacturing an article.

### Description of the Related Art

An imprint technique for transferring a pattern formed on a mold onto a substrate has received attention as a lithography technique used for manufacturing a semiconductor device. In an imprint apparatus that uses the imprint technique, a mold and an imprint material on a substrate are brought into contact with each other, and the imprint material is cured in this state. Then, the mold is separated from the cured imprint material on the substrate to transfer the pattern of the mold to the substrate.

The pattern of the mold needs to be transferred with high accuracy to the substrate in an imprint apparatus. Thus, a technique for correcting the shape of a pattern (pattern region) of a mold and a technique for correcting a transfer region (shot region) on a substrate are proposed in Japanese Patent Laid-Open No. 2008-504141 and Japanese Patent Laid-Open No. 2013-102132, respectively. Japanese Patent Laid-Open No. 2008-504141 discloses a technique in which the shape of the pattern is corrected by applying a force from the side surface of the mold. Japanese Patent Laid-Open No. 2013-102132 discloses a technique in which the shape of the transfer region is corrected by heating the substrate.

However, although the technique disclosed in Japanese Patent Laid-Open No. 2008-504141 is suitable for correcting the magnification or a low-order shape such as a rhombus or the like, it is not suitable for correcting a higher-order shape such as an arc or the like because there is a limit to the number of actuators that can be arranged on the side surface of the mold. Also, in the imprint apparatus, since the mold and the substrate will come into contact with each other via the imprint material, the technique disclosed in Japanese Patent Laid-Open No. 2013-102132 will deform the mold because the heat of the substrate will be transferred to the mold. In particular, if the difference between the linear expansion coefficient of the mold and that of the substrate is small, it will be difficult to relatively deform the shape of the pattern of the mold and the shape of the transfer region of the substrate.

### SUMMARY OF THE INVENTION

The present invention provides an imprint method advantageous in the point of accuracy of an imprint material pattern to be formed on a substrate.

According to one aspect of the present invention, there is provided an imprint method of forming a pattern of an imprint material on a substrate by using a mold, the method including obtaining, before bringing the mold and the imprint material into contact with each other, a correction parameter for correcting deformation of a pattern of the mold caused by bringing the mold and the imprint material on the substrate into contact with each other, and reducing the deformation of the pattern of the mold by moving at least one of the mold and the substrate by a moving unit configured to relatively move the mold and the substrate in a direction parallel to a surface of the substrate in accordance with the correction parameter in a state in which the mold and the imprint material on the substrate are in contact with each other.

Further aspects of the present invention will become apparent from the following description of exemplary embodiments with reference to the attached drawings.

### BRIEF DESCRIPTION OF THE DRAWINGS

FIG. 1 is a schematic view showing the arrangement of an imprint apparatus as an aspect of the present invention.

FIG. 2 is a flowchart for explaining an imprint process of the imprint apparatus shown in FIG. 1.

FIGS. 3A and 3B are views each schematically showing a mold, a mold stage, a substrate, and a substrate stage.

FIG. 4 is a plan view showing a transfer region of the substrate.

FIGS. 5A 5B, and 5C are views for explaining the determination of a target movement amount of the substrate.

FIG. 6 is a schematic view showing the arrangement of the imprint apparatus as another aspect of the present invention.

FIGS. 7A and 7B are views each showing the arrangement of a digital mirror device.

FIGS. 8A to 8C are views for explaining light irradiation performed by a preliminary irradiation unit of the imprint apparatus shown in FIG. 6.

FIGS. 9A to 9F are views for explaining a method of manufacturing an article.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

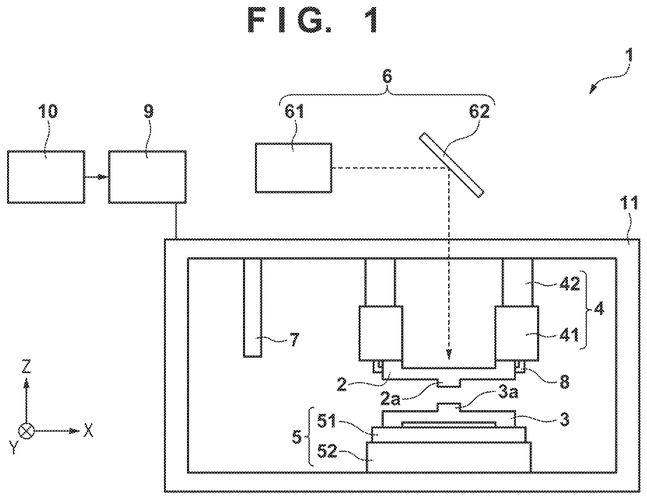

FIG. 1 is a schematic view showing the arrangement of an imprint apparatus 1 as one aspect of the present invention. The imprint apparatus 1 is a lithography apparatus that forms an imprint material pattern on a substrate by using a mold and is employed in a process of manufacturing a semiconductor device or a liquid crystal display element or a process of replicating the mold (process of manufacturing a replica mold). In this embodiment, the imprint apparatus 1 brings a mold and an imprint material supplied on a substrate into contact with each other and applies a curing energy on the imprint material to form a pattern of a cured product onto which the concave-convex pattern of a mold has been transferred.

A curable composition (to be also referred to as uncured resin) to be cured by receiving the curing energy is used as an imprint material. Examples of the curing energy are an electromagnetic wave, heat, and the like. The electromagnetic wave is, for example, light selected from the wavelength range of 10 nm or more to 1 mm or less. Examples of the electromagnetic wave can be infrared light, a visible light beam, and ultraviolet light.

The curable composition can be a composition cured with light irradiation or heating. The photo-curable composition cured by light irradiation contains at least a polymerizable composition and a photopolymerization initiator, and may further contain a nonpolymerizable compound or a solvent, as needed. The nonpolymerizable compound is at least one material selected from the group consisting of a sensitizer, a hydrogen donor, an internal mold release agent, a surfactant, an antioxidant, and a polymer component.

The imprint material can be supplied on the substrate in the form of a film by a spin coater or a slit coater. The imprint material also may be applied on the substrate in the form of droplets or in the form of an island or a film obtained by connecting a plurality of droplets supplied by a liquid injection head. The viscosity (the viscosity at 25° C.) of the imprint material is, for example, 1 mPa·s or more to 100 mPa·s or less.

A substrate to be used is made of glass, ceramic, a metal, a semiconductor, and resin. A member formed from a material different from a substrate may be formed on its surface, as needed. More specifically, a substrate to be used includes a silicon wafer, a compound semiconductor wafer, and a silica Mass wafer.

In this embodiment, the imprint apparatus 1 employs a photo-curing method as the imprint material curing method. However, the imprint material curing method is not limited to the photo-curing method, and the imprint apparatus may employ, for example, a heat-curing method. Also, in this embodiment, the mold is set as a master mold and the substrate is set as a blank mold to manufacture a replica mold. Note that the three axes which are perpendicular to each other are defined as the X-, Y-, and X-axes in FIG. 1.

The imprint apparatus 1 includes, as shown in FIG. 1, a mold stage 4 that holds a mold 2 (master mold), a substrate stage 5 that holds a substrate 3 (blank mold), an irradiation unit 6, a supply unit 7, a mold deformation unit 8, a control unit 9, and a console unit 10.

The mold 2 has a rectangular peripheral shape and includes a pattern 2a (a concave-convex pattern to be transferred to the substrate 3) which is three-dimensionally formed on a surface (pattern surface) facing the substrate 3. The mold 2 is made of a material such as, for example, quartz that can transmit light (ultraviolet light) for curing the imprint material on the substrate.

The substrate 3 that includes a transfer region 3a (shot region) to which the pattern 2a of the mold 2 is to be transferred is a so-called blank mold which is a substrate made of the same material and having the same shape as the mold 2 in this embodiment. However, the substrate 3 is not limited to the blank mold and may use, for example, a single-crystal silicon substrate or an SOI (silicon on insulator) substrate as described above when a semiconductor device is to be manufactured.

The mold stage 4 includes a mold holding unit 41 that holds the mold 2 by a vacuum chucking force or an electrostatic force and a mold moving unit 42 that moves the mold holding unit 41 in the Z direction. Each of the mold holding unit 41 and the mold moving unit 42 has an opening at a center portion (inside) so that the light from the irradiation unit 6 will irradiate the imprint material on the substrate.

The mold moving unit 42 includes, for example, an actuator such as a voice coil motor, an air cylinder, or the like. The mold moving unit 42 moves the mold holding unit 41 (the mold 2) in the Z direction to bring the mold 2 into contact with the imprint material on the substrate and to separate the mold 2 from the imprint material on the substrate. The mold moving unit 42 may be formed to have a function of adjusting the position of the mold holding unit 41 not only in the Z direction, but also in the X direction and the Y direction. In addition, the mold moving unit 42 may be formed to have a function for adjusting the position of the mold holding unit 41 in the θ (rotation about the Z axis) direction or a tilt function for adjusting the tilt of the mold holding unit 41.

The substrate stage 5 includes the substrate holding unit 51 that holds the substrate 3 by a vacuum chucking force or an electrostatic force and a substrate moving unit 52 that moves the substrate holding unit 51 (the substrate 3) in the X direction and the Y direction. The substrate moving unit 52 includes, for example, a linear motor and may be formed by a plurality of driving systems such as a coarse driving system, a fine driving system, and the like. The substrate moving unit 52 may be formed to have a function for adjusting the position of the substrate holding unit 51 not only in the X direction and the Y direction, but also in the Z direction. In addition, the substrate moving unit 52 may be formed to have a function for adjusting the position of the substrate holding unit 51 in the 8 (rotation about the Z axis) direction or a tilt function for adjusting the tilt of the substrate holding unit 51.

In this embodiment, the mold moving unit 42 and the substrate moving unit 52 function as moving units that relatively move the mold 2 and the substrate 3, respectively, in a direction (X direction) parallel to the surface of the substrate 3. Each of the moving units can move at least the corresponding one of the mold 2 and the substrate 3 in a state in which the mold 2 and the imprint material on the substrate are in contact with each other as described above.

To measure the position of the substrate stage 5, for example, an encoder system which is formed by a scale arranged in a housing 11 and a head (an optical device) arranged in the substrate moving unit 52 is used. The scale may be arranged in the substrate moving unit 52. However, note that the measurement of the position of the substrate stage 5 is not limited to the encoder system. An interferometer system formed by a laser interferometer arranged in the housing 11 and a reflecting mirror arranged in the substrate moving unit 52 may be used.

In general, the accuracy required for the imprint apparatus when a replica mold is to be manufactured is of a nm order for the accuracy related to the shape of the pattern to be transferred to the substrate, and is of a μm order for the accuracy (shift amount) related to the position of the pattern to be transferred to the substrate. Hence, even if the position of the substrate 3 with respect to the housing 11 is controlled by using the encoder system or the interferometer system, the relative position (shift amount) between the pattern 2a of the mold 2 and the transfer region 3a of the substrate 3 can be controlled with sufficient accuracy.

On the other hand, in a certain case, the accuracy required when an imprint apparatus is to manufacture a semiconductor device may be of a nm order for the accuracy related to the position of the pattern to be transferred to the substrate. In such a case, the imprint apparatus 1 may include an alignment measurement system (not shown). The alignment measurement system measures the relative position and the shape difference between the pattern 2a and the transfer region 3a by observing a plurality of marks provided on the pattern 2a (pattern region) of the mold 2 and a plurality of marks provided on the transfer region 3a of the substrate 3. Note that in this embodiment, the transfer accuracy of the pattern to be transferred to the substrate 3 can be improved regardless of whether the imprint apparatus 1 includes an alignment measurement system.

The irradiation unit 6 includes a light source 61 which emits light for curing the imprint material on the substrate and an optical member 62 which guides the light emitted from the light source 61 to the imprint material on the substrate, and the irradiation unit irradiates the imprint material on the substrate with light via the mold 2. The optical member 62 includes an optical element for adjusting the light emitted from the light source 61 into light suitable for the imprint process.

The supply unit 7 (dispenser) supplies (applies) an uncured imprint material to the substrate. In this embodiment, the imprint material is a photo-curing imprint material that has a property of being curable by light irradiation.

The mold deformation unit 8 corrects the shape of the pattern 2a of the mold 2 (that is, deforms the shape of the pattern 2a) by applying a force to (each side surface of) the mold 2 in a direction parallel to the pattern region of the mold 2. The mold deformation unit 8 includes, for example, a plurality of actuators and is formed to apply the pressure to a plurality of locations on each side surface of the mold 2.

The control unit 9 is formed by a computer including a CPU, a memory and the like, and controls the overall imprint apparatus 1 in accordance with a program stored in the memory. The control unit 9 controls the operation and adjustment of each unit of the imprint apparatus 1 to transfer the pattern 2a of the mold 2 to the imprint material on the substrate, that is, to control the imprint process of forming a pattern on a substrate.

The console unit 10 includes a computer provided with a display and input devices such as a keyboard and a mouse, and is an interface for sharing information between the imprint apparatus 1 (the control unit 9) and a user. The console unit 10 transmits (outputs), to the control unit 9, information related to the imprint process which has been input by the user. The information related to the imprint process that is input to the console unit 10 is stored in the computer as a recipe parameter or a log and can be confirmed before or after the imprint process.

In this embodiment, the console unit 10 also functions as a user interface for inputting a correction parameter for correcting the deformation of the pattern 2a of the mold 2 caused by bringing the mold 2 and the imprint material on the substrate into contact with each other. Also, in this embodiment, the control unit 9 functions as an obtainment unit that obtains the correction parameter input to the console unit 10.

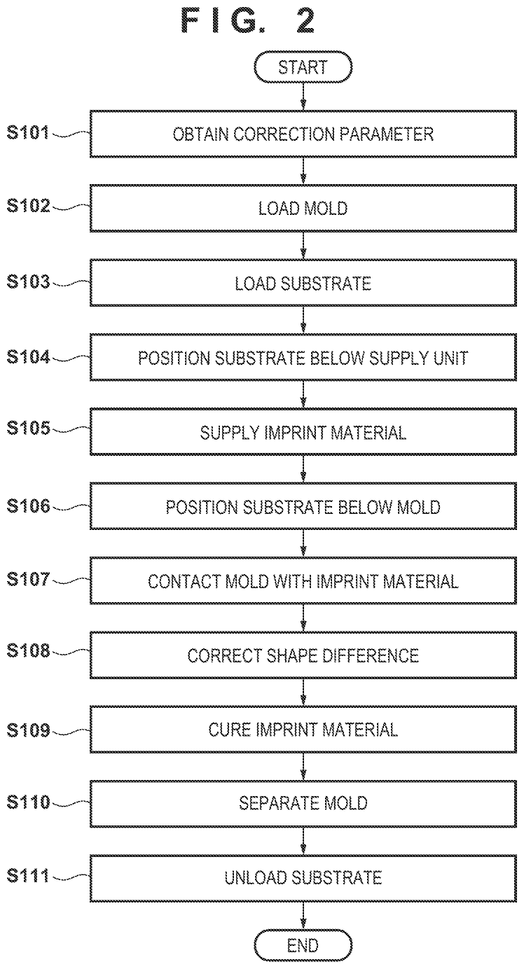

An imprint process performed in the imprint apparatus 1 will be described with reference to FIG. 2. The imprint process is performed by the control unit 9 integrally controlling each unit of the imprint apparatus 1 in the manner described above. FIG. 2 is a flowchart for explaining the imprint process performed in the imprint apparatus 1.

In step S101, the control unit obtains a correction parameter, which is input to the console unit 10 by the user, for correcting the deformation of the pattern 2a of the mold 2 caused by bringing the mold 2 into contact with the imprint material on the substrate. A target movement amount (the target value of a movement amount) of at least one of the mold 2 and the substrate 3 moved by the corresponding one of the mold moving unit 42 and the substrate moving unit 52 in a state in which the mold 2 and the imprint material on the substrate are in contact with each other will be exemplified as the correction parameter in this case.

In step S102 the mold 2 is loaded into the imprint apparatus 1. More specifically, a mold conveyance mechanism (not shown) loads (conveys) the mold 2 to a position below the mold holding unit 41 of the imprint apparatus 1 and causes the mold holding unit 41 to hold the mold 2.

In step S103, the substrate 3 is loaded into the imprint apparatus 1. More specifically, a substrate conveyance mechanism (not shown) loads (conveys) the substrate 3 to a position above the substrate holding unit 51 of the imprint apparatus 1 and causes the substrate holding unit 51 to hold the substrate 3.

In step S104, the substrate 3 is positioned below (the imprint material supplying position) the supply unit 7. More specifically, the substrate moving unit 52 moves the substrate holding unit 51 which holds the substrate 3 so that the transfer region 3a of the substrate 3 will be positioned below the supply unit 7.

In step S105, the supply unit 7 supplies the imprint material to the transfer region 3a of the substrate 3.

In step S106, the substrate 3 is positioned below the mold 2. More specifically, the substrate moving unit 52 moves the substrate holding unit 51 holding the substrate 3 so that the transfer region 3a of the substrate 3 on which the imprint material has been supplied will be positioned below the pattern 2a of the mold 2. At this time, the substrate moving unit 52 will move the substrate 3 in accordance with a command value for positioning the substrate 3 at a default position below the mold 2 that has been preset based on a design value or the like.

In step S107, the mold 2 and the imprint material on the substrate are brought into contact with each other. More specifically, the mold moving unit 42 moves the mold 2 (lowers the mold 2) in the Z direction so as to bring the pattern 2a of the mold 2 into contact with the imprint material on the transfer region of the substrate 3, that is, so as to reduce the distance between the mold 2 and the substrate 3. The imprint material fills (the concave portion of) the pattern 2a of the mold 2 when the mold 2 and the imprint material on the substrate are in contact with each other.

In step S108, the shape difference between the pattern 2a of the mold 2 and the transfer region 3a of the substrate 3 is corrected. More specifically, the mold deformation unit 8 and the substrate moving unit 52 are controlled so that the shape of the pattern 2a of the mold 2 and the shape of the transfer region 3a of the substrate 3 will match. In the correction performed by the mold deformation unit 8, a force is applied to a side surface of the mold 2 so as to correct a shape difference due to low-order components such as the magnification, rotation, or the like. Note that the correction by the mold deformation unit 8 may be performed before the process of step S108. In the correction performed by the substrate moving unit 52, the substrate 3 is moved in the X direction in accordance with the correction parameter, that is, the target movement amount obtained in step S101 so as to correct a shape difference due to higher-order components such as a higher-order decentering, an arc, or the like (to reduce the deformation of the pattern 2a of the mold 2). Note that in a case in which a shape difference due to a higher-order component can be corrected by the mold deformation unit 8 depending on the shape, the correction by the mold deformation unit 8 and the substrate moving unit 52 may be combined. The correction performed by the substrate moving unit 52 will be described in detail later.

In step S109, the imprint material is cured in a state in which the mold 2 and the imprint material on the substrate are in contact with each other. More specifically, the imprint material in contact with the pattern 2a of the mold 2 is irradiated with light from the irradiation unit 6 to cure the imprint material.

In step S110, the mold 2 is separated from the cured imprint material on the substrate. More specifically, the mold moving unit 42 moves the mold 2 (raises the mold 2) in the Z direction so as to separate the mold 2 from the imprint material on the substrate, that is, to increase the distance between the mold 2 and the substrate 3.

In step S111, the substrate 3 is unloaded from the imprint apparatus 1. More specifically, the substrate conveyance mechanism (not shown) collects the substrate 3 from the substrate holding unit 51 and conveys the substrate outside the imprint apparatus 1.

The correction (the correction of the shape difference between the pattern 2a of the mold 2 and the transfer region 3a of the substrate 3) performed by the substrate moving unit 52 in step S108 will be described. First, the shape difference which is a difference between the shape of the pattern 2a of the mold 2 and the shape of the transfer region 3a of the substrate 3 before the correction will be described.

The substrate 3, on which the imprint process in the imprint apparatus 1 is performed, can become deformed due to warping by, for example, undergoing a heating process in a film formation process such as sputtering in the series of manufacturing processes, and thus the transfer region 3a can become distorted. The distortion of the transfer region 3a of the substrate 3 can also occur if there is a difference between the flatness of the substrate 3 and the flatness of the holding surface on which the substrate holding unit 51 holds the substrate 3. On the other hand, the pattern 2a can also become distorted in the mold 2 due to the following causes. For example, although the pattern 2a is formed (drawn) on the mold 2 by a drawing device which uses an electron beam or the like in general, the pattern 2a can become distorted due to the aberration of the optical system of the drawing device. Also, since the pattern surface is faced downward when the imprint process is to be performed even though the surface (the pattern surface) on which the pattern 2a is formed is faced upward when the mold 2 is manufactured, the distortion of the pattern 2a can occur due to gravity and the contact (pressing) with the imprint material. Furthermore, the distortion of the pattern 2a can occur even when there is a difference between the flatness of a surface (holding surface) on which the mold holding unit 41 holds the mold 2 and the flatness of the surface (the surface to be held by the mold holding unit 41) on the opposite side of the pattern surface of the mold 2. When there is a difference between the distortion of the pattern 2a of the mold 2 and the distortion of the transfer region 3a of the substrate 3, a difference (shape difference) is generated between the shape of the pattern 2a and the shape of the transfer region 3a. The shape differences include those due to not only low-order components such as the magnification, a rhombus, and the like, but also those due to higher-order components such as an arc, higher-order decentering, and the like.

In the imprint apparatus 1, the shape difference between the pattern 2a of the mold 2 and the transfer region 3a of the substrate 3 is corrected by the mold deformation unit 8 and the substrate moving unit 52 as described above. Since there is a limit to the number of actuators that can form the mold deformation unit 8, the mold deformation unit 8 is not suitable for performing higher-order-component shape correction. Hence, in this embodiment, the mold deformation unit 8 will correct a low-order component, and the substrate moving unit 52 will correct a higher-order component.

Since the pattern 2a of the mold 2 and the imprint material on the substrate are in contact with each other in step S108, the interval between the pattern 2a and the transfer region 3a (that is, the thickness of the imprint material sandwiched by the mold 2 and the substrate 3) is equal to or less than 100 nm. In this manner, since the molecular motion of the liquid is restricted (the liquid is structured) when the liquid is sandwiched on a urn order, the behavior of the liquid cannot be that of a Newtonian fluid and will be like the behavior of a viscoelastic body. Although the viscoelastic resistance force will be zero when the shear rate is set to zero in the case of the Newtonian fluid, a displacement will be generated in the shear direction in a state in which the liquid is structured, and the resistance force will remain even if the shear rate is set to zero while this displacement is maintained. Therefore, when the substrate 3 is moved by the substrate moving unit 52 in the X direction, a relative displacement is generated between the pattern 2a of the mold 2 and the transfer region 3a of the substrate 3, and the resistance force (a force in the X direction) is applied to at least one of the pattern 2a and the transfer region 3a via the imprint material. As a result, the pattern 2a of the mold 2 and the transfer region 3a of the substrate 3 are deformed.

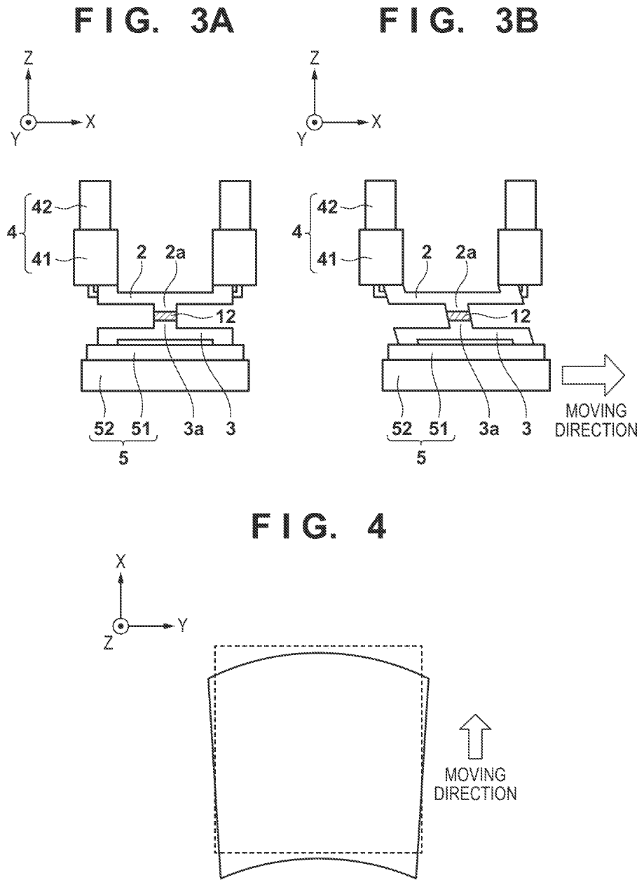

FIGS. 3A and 3B are views each schematically showing the mold 2, the mold stage 4, the substrate 3, and the substrate stage 5 in a state in which an imprint material 12 is sandwiched between the mold 2 and the substrate 3. Each of FIGS. 3A and 3B is a view taken along a Y-Z plane, and the imprint material 12 sandwiched between the mold 2 and the substrate 3 is structured. Although the thickness of the imprint material 12 in the Z direction is actually equal to or less than 100 nm and is smaller than the thickness of the substrate 3 and the mold 2 in the Z direction, the thickness of the imprint material 12 in the Z direction is shown enlarged in FIGS. 3A and 3B.

FIG. 3A shows a state in which the pattern 2a of the mold 2 and the imprint material 12 on the substrate are in contact with each other. FIG. 3B shows a state in which the substrate 3 has been moved in the X direction (the +direction of the X-axis) from the state shown in FIG. 3A by the substrate moving unit 52. As shown in FIG. 3B, when the imprint material 12 is structured, a force is transmitted between the pattern 2a of the mold 2 and the transfer region 3a of the substrate 3 via the imprint material 12, thus deforming the pattern 2a and the transfer region 3a. For example, when the substrate 3 is moved in the +direction of the X-axis, the mold 2 (pattern 2a) is deformed so that the mold is pulled in the +direction of the X-axis via the imprint material 12. Although the substrate 3 will try to move in the +direction of the X-axis, a force will be applied so that the substrate will be kept at the mold 2 via the imprint material 12. The deformation (shape) of the substrate 3 changes depending on the shape of the substrate 3, the rigidity, the shape of the holding surface of the substrate holding unit 51, and the like. In a similar manner, the deformation (shape) of the mold 2 changes depending on the shape of the mold 2, the rigidity, the shape of the holding surface of the mold holding unit 41, and the like. Hence, the deformation can be controlled by the shape of at least one of the mold 2 and the substrate 3 or the shape of the holding surface. For example, if the shape of the holding surface of the mold holding unit 41 is an annular shape that surrounds the pattern 2a of the mold 2, the deformation (shape) of the pattern 2a will include an arc.

FIG. 4 is a plan view showing the transfer region 3a of the substrate 3. In FIG. 4, a solid line indicates the shape (deformed shape) of the transfer region 3a of the substrate 3 with respect to the pattern 2a of the mold 2 after the substrate moving unit 52 has moved the substrate 3 in the X direction in a state in which the mold 2 and the imprint material on the substrate are in contact. In addition, broken lines indicate the shape of the transfer region 3a of the substrate 3 with respect to the pattern 2a of the mold 2 before the substrate moving unit 52 has moved the substrate 3 in the X direction in a state in which the mold 2 and the imprint material on the substrate are in contact. However, although the deformation amount of the transfer region 3a of the substrate 3 is actually equal to or less than 1 μm and is very small compared to the size of the transfer region 3a, the deformation amount of the transfer region 3a is enlarged and shown in FIG. 4. FIG. 4 shows the shape of the transfer region 3a obtained when the substrate moving unit 52 has moved the substrate 3 in the +direction of the X-axis, and a force in one direction of the X-axis is applied to the transfer region 3a. As shown in FIG. 4, the shape (deformed shape) of the transfer region 3a of the substrate 3 is a shape that includes an arc.

The target movement amount (correction parameter) of the substrate 3 is determined as follows. First, a test imprint operation is performed to obtain the shape difference between the pattern 2a of the mold 2 and the transfer region 3a of the substrate 3 when the substrate moving unit 52 does not move the substrate 3 in a state in which the mold 2 and the imprint material on the substrate are in contact with each other. In a similar manner, a test imprint operation is performed to obtain the shape difference between the pattern 2a of the mold 2 and the transfer region 3a of the substrate 3 when the substrate moving unit 52 moves the substrate 3 by a predetermined amount in a state in which the mold 2 and the imprint material on the substrate are in contact with each other. As a result of these two test imprint operations, that is, based on the relationship between the two shape differences obtained from the test imprint operations, the movement amount of the substrate 3 which minimizes the shape difference between the pattern 2a of the mold 2 and the transfer region 3a of the substrate 3 is determined to be the target movement amount. Note that the test imprint operation can be replaced by a simulation. Also, in a case in which the imprint apparatus 1 includes an alignment measurement system, the target movement amount of the substrate 3 may be determined from the shape difference between the pattern 2a of the mold 2 and the transfer region 3a of the substrate 3 that has been measured by the alignment measurement system.

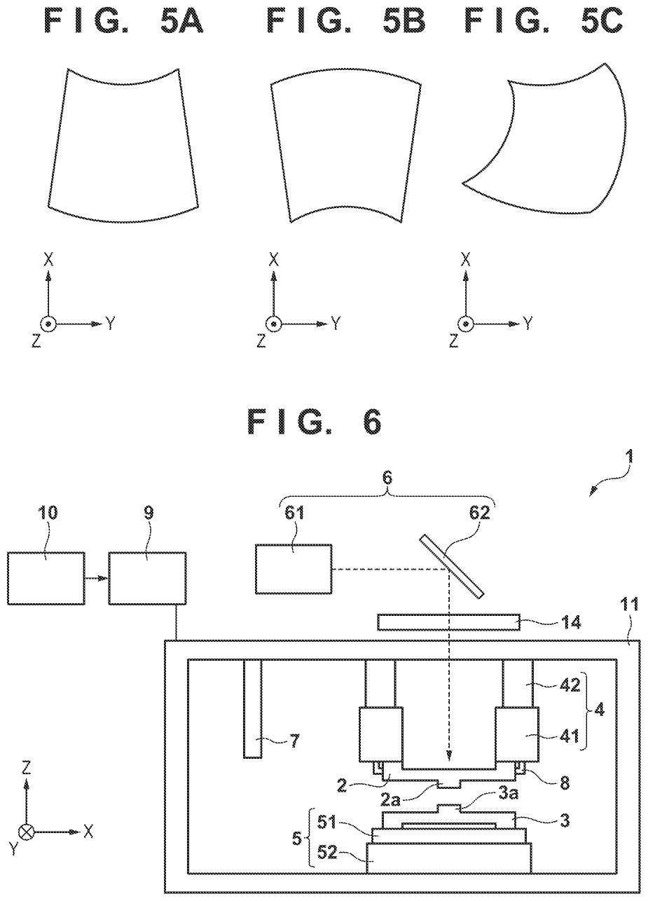

FIG. 5A shows the shape difference between the pattern 2a of the mold 2 and the transfer region 3a of the substrate 3 when the substrate moving unit 52 does not move the substrate 3 in a state in which the mold 2 and the imprint material on the substrate are in contact with each other. FIG. 5B shows the shape difference between the pattern 2a of the mold 2 and the transfer region 3a of the substrate 3 when the substrate moving unit 52 has moved the substrate 3 by a predetermined amount in the +direction of the X-axis in a state in which the mold 2 and the imprint material on the substrate are in contact with each other. FIG. 5C shows the shape difference between the pattern 2a of the mold 2 and the transfer region 3a of the substrate 3 when the substrate moving unit 52 has moved the substrate 3 by a predetermined amount in the +direction of the Y-axis in a state in which the mold 2 and the imprint material on the substrate are in contact with each other. In this case, a shape difference due to a higher-order component can be reduced if the target movement amount, which is used by the substrate moving unit 52 to move the substrate 3 in the +direction of the X-axis, is set to half of the predetermined amount. A more suitable target movement amount can be determined, for example, by executing the least squares method based on the shape differences shown in FIGS. 5A, 5B, and 5C.

In this embodiment, although the substrate 3 is moved so that the transfer region 3a of the substrate 3 will be at a position below the pattern 2a of the mold 2 in step S106, a positional shift will occur between the pattern 2a and the transfer region 3a if the substrate 3 is moved further in step S108. Hence, a movement amount obtained by subtracting the movement amount of the substrate 3 in step S108 from the movement amount of the substrate 3, required to arrange the transfer region 3a of the substrate 3 below the pattern 2a of the mold 2, can be set as the target movement amount of the substrate 3.

In addition, although the correction parameter has been described as the target movement amount of the substrate 3 in this embodiment, the present invention is not limited to this. The correction parameter may be the target value of the force applied to at least one of the mold 2 and the substrate 3 via the imprint material when the mold 2 and the substrate 3 are to be moved in a direction parallel to the surface of the substrate 3 in a state in which the mold 2 and the imprint material on the substrate are in contact with each other. The target value of the force may be determined as follows. First, a test imprint operation is performed to obtain the shape difference between the pattern 2a of the mold 2 and the transfer region 3a of the substrate 3 when the substrate moving unit 52 does not move the substrate 3 in a state in which the mold 2 and the imprint material on the substrate are in contact with each other. Next, a test imprint operation is performed to obtain the shape difference between the pattern 2a of the mold 2 and the transfer region 3a of the substrate 3 when a predetermined amount of force which is parallel to the surface of the substrate 3 is applied to at least one of the mold 2 and the substrate 3 in a state in which the mold 2 and the imprint material on the substrate are in contact with each other. As a result of these two test imprint operations, that is, based on the relationship between the two shape differences obtained by the test imprint operations, a force that will minimize the shape difference between the pattern 2a of the mold 2 and the transfer region 3a of the substrate 3 is determined as the target value. Note that each test imprint operation can be replaced by a simulation. In addition, the force parallel to the surface of the substrate 3 and applied to the at least one of the mold 2 and the substrate 3 can be measured from the driving force of the substrate moving unit 59.

Also, in a case in which the correction parameter is the target value of the force applied to at least one of the mold 2 and the substrate 3, the process of step S108 can be replaced by the following process. First, the force applied to at least one of the mold 2 and the substrate 3 in a state in which the mold 2 and the imprint material on the substrate are in contact with each other is measured. Subsequently, at least one of the mold 2 and the substrate 3 is moved by the corresponding one of mold moving unit 42 and the substrate moving unit 52 until the measured force reaches the target value. Also, an underlying pattern or the like need not be formed in advance on the transfer region 3a of the substrate 3. For example, in an imprint apparatus for manufacturing a replica mold, a master mold will be used as the mold 2 and a mold (blank mold) without pattern formation will be used as the substrate 3. Hence, the transfer region 3a may not be formed in advance on the blank mold that is to serve as the substrate. In such a case, the transfer region 3a of the substrate 3 may be assumed to have the shape (design value shape) of the pattern region formed on the master mold. That is, the shape of the pattern formed on the blank mold by using the master mold can be measured, and the difference between this pattern formed on the blank mold and the pattern region (design value shape) formed on the master mold can be set as the shape difference between the pattern 2a and the transfer region 3a as described above.

In this manner, by moving at least one of the mold 2 and the substrate 3 by the corresponding one of the mold moving unit 42 and the substrate moving unit 52 in a state in which the mold 2 and the imprint material on the substrate are in contact with each other, it is possible to correct the shape difference between the pattern 2a and the transfer region 3a. Hence, this embodiment is advantageous in the point of the accuracy of the imprint material pattern formed on the substrate.

In addition, the imprint apparatus 1 may include a preliminary irradiation unit 14 as shown in FIG. 6. The preliminary irradiation unit 14 irradiates the imprint material on the substrate with light that increases the viscosity of the imprint material without completely curing the imprint material.

Light irradiation by the preliminary irradiation unit 14 is performed before the process of step S108, for example, before the mold 2 and the imprint material on the substrate are brought into contact with each other or before the substrate moving unit 52 moves the substrate 3 in a state in which the mold 2 and the imprint material on the substrate are in contact with each other. The viscosity of the imprint material on the substrate increases when it is irradiated with the light from the preliminary irradiation unit 14. When the substrate moving unit 52 moves the substrate 3 in a state in which the mold 2 and the imprint material on the substrate are in contact with each other after the viscosity of the imprint material on the substrate has increased, the force applied to at least one of the mold 2 and the substrate 3 increases with respect to the movement amount of the substrate 3. Hence, this increases a stroke that can correct the shape difference between the pattern 2a of the mold 2 and the transfer region 3a of the substrate 3.

In this embodiment, the light source 61 of the irradiation unit 6 is used also as the light source of the preliminary irradiation unit 14. However, the imprint material on the substrate may become completely cured if the light emitted from the light source 61 is directly used since the light sensitivity of the imprint material is high. Hence, the preliminary irradiation unit 14 will increase the viscosity of the imprint material on the substrate without completely curing the imprint material by removing some of the wavelengths of the light or attenuating a predetermined amount of the light emitted from the irradiation unit 6. More specifically, the use of an optical filter (optical element) that shields (separates) light by reflecting or absorbing some of the wavelengths of light from the irradiation unit 6, a shutter that restricts the light transmittance amount by decreasing the opening of a pinhole, or the like can be considered. Note that instead of using the light source 61 of the irradiation unit 6, a dedicated light source (a light source different from the light source 61) may be provided in the preliminary irradiation unit 14.

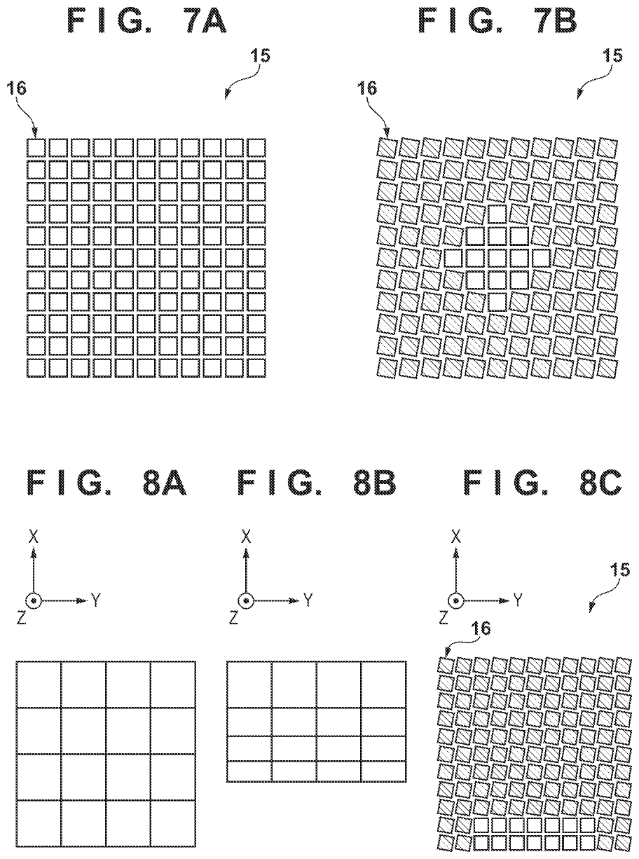

In addition, the preliminary irradiation unit 14 may also include a digital mirror device (DMD) 15 as shown in FIGS. 7A and 7B. The DMD 15 includes a plurality of mirror elements 16 arranged in a two-dimensional manner (in a matrix), and the irradiation amount and the irradiation position of the light emitted from the preliminary irradiation unit 14 onto the substrate can be adjusted by individually controlling (adjusting) each mirror element 16 in the surface direction. Hence, the preliminary irradiation unit 14 can perform light irradiation on only a partial region of the imprint material contacting region on the substrate which is in contact with the mold 2. Note that of the imprint material contacting region on the substrate which is in contact with the mold 2, the partial region to be irradiated with light from the preliminary irradiation unit 14 may be determined based on the shape difference between the pattern 2a of the mold 2 and the transfer region 3a of the substrate 3.

In this embodiment, the DMD 15 can change each of the mirror elements 16 in the surface direction under the control of the control unit 9. In this manner, the DMD 15 can change the light reflection direction and can form an arbitrary irradiation amount distribution on the imprint material on the substrate. For example, in a case in which the viscosity of the imprint material (the central portion of the imprint material) which is to be in contact with the pattern 2a of the mold 2 is to be increased, the reflection direction of each mirror element 16 of the DMD 15 is changed as shown in FIG. 7B. In FIG. 7B, the mirror elements 16 which are to reflect the light from the irradiation unit 6 and irradiate the imprint material on the substrate with the reflected light are indicated in white.

In this manner, by forming an irradiation amount distribution of light to be emitted from the preliminary irradiation unit 14, it is possible to form an arbitrary distribution corresponding to the magnitude of the force to be applied between the pattern 2a of the mold 2 and the transfer region 3a of the substrate 3 by the movement of the substrate 3. As a result, it increases the degree of freedom at which the shape difference between the pattern 2a of the mold 2 and the transfer region 3a of the substrate 3 can be corrected. In particular, it is preferable to increase the viscosity of the imprint material at a location where the shape difference between the between the pattern 2a of the mold 2 and the transfer region 3a of the substrate 3 is large.

FIGS. 8A and 8B are plan views showing the transfer region 3a of the substrate 3. In FIG. 8A, the shape of the pattern 2a of the mold 2 to be transferred to the transfer region 3a of the substrate 3 is shown as a matrix. In FIG. 8B, the pattern 2a of the mold 2 that has been transferred to the transfer region 3a of the substrate 3 when the substrate moving unit 52 does not move the substrate 3 in a state in which the mold 2 is in contact with the imprint material on the substrate is shown as a matrix. Referring to FIG. 8B, a region in one direction of the X-axis of the pattern 2a of the mold 2 which has been transferred to the transfer region 3a of the substrate 3 has shrunk compared to that shown in FIG. 8A. In this case, as shown in FIG. 8C, among the mirror elements 16 of the DMD 15, the reflection direction of each mirror element 16 arranged in a region other than the region in the one direction of the X-axis is changed to increase the viscosity of the imprint material present in the region in the one direction of the X-axis. Subsequently, the substrate moving unit 52 can move the substrate 3 in the +direction of the X-axis in a state in which the mold 2 and the imprint material on the substrate are in contact with each other. Note that the reflection direction of each mirror element 16 of the DMD 15 and the viscosity distribution of the imprint material on the substrate can be set via the console unit 10.

The imprint apparatus 1 can be used not only to replicate the mold as described above, but also to manufacture various kinds of articles. The pattern of a cured product formed using the imprint apparatus 1 is used permanently for at least some of various kinds of articles or temporarily when manufacturing various kinds of articles. The articles are an electric circuit element, an optical element, a MEMS, a recording element, a sensor, a mold, and the like. Examples of the electric circuit element are volatile and nonvolatile semiconductor memories such as a DRAM, a SRAM, a flash memory, and a MRAM and semiconductor elements such as an LSI, a CCD, an image sensor, and an FPGA. Examples of the mold are molds for imprint.

The pattern of the cured product is directly used as at least a part of the constituent member of the above-described article or used temporarily as a resist mask. After etching or ion implantation is performed in the substrate processing step, the resist mask is removed.

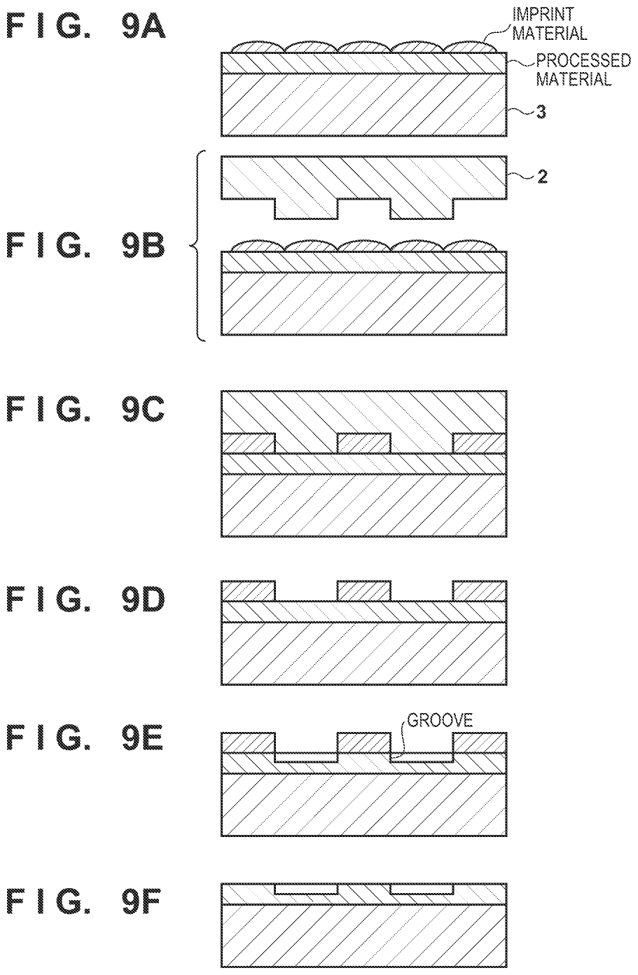

A more specific method of manufacturing an article will be described next. As shown in FIG. 9A, the substrate 3 such as a silicon wafer with a processed material such as an insulator formed on the surface is prepared. Next, the imprint material is applied to the surface of the processed material by an inkjet method or the like. A state in which the imprint material is applied as a plurality of droplets onto the substrate is shown here.

As shown in FIG. 9B, a side of the mold 2 for imprint with a convex-concave pattern is directed and made to face the imprint material on the substrate. As shown in FIG. 9C, the substrate 3 to which the imprint material is applied is brought into contact with the mold 2, and a pressure is applied. The gap between the mold 2 and the processed material is filled with the imprint material. The imprint material is cured when it is irradiated with energy for curing via the mold 2 in this state.

As shown in FIG. 9D, after the imprint material is cured, the mold 2 is separated from the substrate 3. Then, the pattern of the cured product of the imprint material is formed on the substrate. In the pattern of the cured product, the concave portion of the mold 2 corresponds to the convex portion of the cured product, and the convex portion of the mold 2 corresponds to the concave portion of the cured product. That is, the concave-convex pattern of the mold 2 has been transferred to the imprint material.

As shown in FIG. 9E, when etching is performed using the pattern of the cured product as an etching resistant mold, a portion of the surface of the processed material where the cured product does not exist or remains thin is removed to form a groove. As shown in FIG. 9F, when the pattern of the cured product is removed, an article with grooves formed in the surface of the processed material can be obtained. Although the pattern of the cured product is removed here, it may be used as, for example, an interlayer dielectric film included in a semiconductor element or the like, that is, a constituent member of an article, instead of processing or removing the pattern of the cured product.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2018-174189 filed on Sep. 18, 2018, which is hereby incorporated by reference herein in its entirety.

What is claimed is:

1. An imprint method of forming a pattern of an imprint material on a substrate by using a mold, the method comprising:
obtaining, before bringing the mold and the imprint material into contact with each other, a correction parameter for correcting deformation of a pattern of the mold caused by bringing the mold and the imprint material on the substrate into contact with each other; and
reducing the deformation of the pattern of the mold by moving at least one of the mold and the substrate by a moving unit configured to relatively move the mold and the substrate in a direction parallel to a surface of the substrate in accordance with the correction parameter in a state in which the mold and the imprint material on the substrate are in contact with each other.

2. The method according to claim 1, wherein the correction parameter includes a target movement amount of at least one of the mold and the substrate to be moved by the moving unit in the state in which the mold and the imprint material on the substrate are in contact with each other.

3. The method according to claim 2, further comprising:
determining the target movement amount based on a relationship between a shape difference between the pattern of the mold and a shot region of the substrate when the mold and the substrate are not moved by the moving unit in the state in which the mold and the imprint material on the substrate are in contact with each other and a shape difference between the pattern of the mold and the shot region of the substrate when at least one of the mold and the substrate is moved by a predetermined amount by the moving unit in the state in which the mold and the imprint material on the substrate are in contact with each other.

4. The method according to claim 1, wherein the correction parameter includes a target value of a force in a direction applied to the at least one of the mold and the substrate when the mold and the substrate are to be moved in the direction in the state in which the mold and the imprint material on the substrate are in contact with each other.

5. The method according to claim 4, wherein the reducing the deformation of the pattern of the mold includes measuring the force in the state in which the mold and the imprint material on the substrate are in contact with each other, and
at least one of the mold and the substrate is moved by the moving unit until the force to be measured reaches the target value in the reducing the deformation of the pattern of the mold.

6. The method according to claim 4, further comprising:
determining the target value based on a relationship between a shape difference between the pattern of the mold and a shot region of the substrate when the mold and the substrate are not moved by the moving unit in the state in which the mold and the imprint material on the substrate are in contact with each other and a shape difference between the pattern of the mold and the shot region of the substrate when a predetermined amount of the force is applied to at least one of the mold and the substrate in the state in which the mold and the imprint material on the substrate are in contact with each other.

7. The method according to claim 1, further comprising:
irradiating the imprint material on the substrate with light that increases viscosity of the imprint material before the reducing the deformation of the pattern of the mold.

8. The method according to claim 1, wherein the reducing the deformation of the pattern of the mold includes irradiating the imprint material on the substrate with light that increases viscosity of the imprint material before the at least one of the mold and the substrate is moved by the moving unit in the state in which the mold and the imprint material on the substrate are in contact with each other.

9. The method according to claim 7, wherein in the irradiating the imprint material on the substrate with light, only a partial region of a contact region of the imprint material in contact with the mold is irradiated with the light.

10. The method according to claim 9, further comprising:
determining the partial region to be irradiated with the light based on the deformation of the pattern of the mold.

11. The method according to claim 1, wherein
the mold includes a master mold, and
the substrate includes a blank mold to which a pattern of the master mold is transferred.

12. An imprint apparatus that forms a pattern of an imprint material on a substrate by using a mold, comprising:
an obtainment unit configured to obtain, before bringing the mold and the imprint material into contact with each other, a correction parameter for correcting deformation of a pattern of the mold caused by bringing the mold and the imprint material on the substrate into contact with each other;
a moving unit configured to relatively move the mold and the substrate in a direction parallel to a surface of the substrate; and
a control unit configured to control the moving unit to move, in accordance with the correction parameter, at least one of the mold and the substrate in a state in which the mold and the imprint material on the substrate are in contact with each other, so as to reduce the deformation of the shape of the pattern of the mold.

13. The apparatus according to claim 12, further comprising:
a console unit configured to cause a user to input the correction parameter,
wherein the obtainment unit obtains the correction parameter input to the console unit.

14. A method of manufacturing an article, comprising:
forming a pattern on a substrate by using an imprint method defined in claim 1; and
processing the substrate on which the pattern has been formed in the forming.

15. A method of manufacturing an article, comprising:
forming a pattern on a substrate by using an imprint apparatus defined in claim 12; and
processing the substrate on which the pattern has been formed in the forming.
